(19) United States
(12) Patent Application Publication
(10) Pub. No.: US 2025/0063539 A1
(43) Pub. Date: Feb. 20, 2025

(54) SYSTEMS AND METHODS FOR HIGH ACCURACY POSITIONING

(71) Applicant: ZTE CORPORATION, Shenzhen (CN)

(72) Inventors: Cong WANG, Shenzhen (CN); Chuangxin JIANG, Shenzhen (CN); Yu PAN, Shenzhen (CN); Focai PENG, Shenzhen (CN); Mengzhen LI, Shenzhen (CN)

(73) Assignee: ZTE CORPORATION, Shenzhen (CN)

(21) Appl. No.: 18/938,717

(22) Filed: Nov. 6, 2024

Related U.S. Application Data
(63) Continuation of application No. PCT/CN2023/087136, filed on Apr. 7, 2023.

(51) Int. Cl. H04W 64/00; H04B 17/318; H04L 5/00

(52) U.S. Cl. CPC H04W 64/00; H04B 17/328; H04L 5/0051

(57) ABSTRACT

Presented are systems and methods for high accuracy positioning. A wireless communication device may determine a first information element and a second information element that configure a pathloss reference signal and a spatial relation of a reference signal for uplink positioning, respectively. The wireless communication device may send the reference signal based on the first information element and the second information element to a wireless communication node.

### CROSS-REFERENCE TO RELATED APPLICATION

This application claims the benefit of priority under 35 U.S.C. § 120 as a continuation of PCT Patent Application No. PCT/CN2023/087136, filed on Apr. 7, 2023, the disclosure of which is incorporated herein by reference in its entirety.

### TECHNICAL FIELD

The disclosure relates generally to wireless communications, including but not limited to systems and methods for high accuracy positioning for low power user equipments (UEs).

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A wireless communication device (e.g., a UE) may determine a first information element (e.g., pathlossReferenceRS-Pos) and a second information element (e.g., SpatialRelationlnfoPos) that configure a pathloss reference signal and a spatial relation of a reference signal for uplink positioning, respectively. The wireless communication device may send the reference signal based on the first information element and the second information element to a wireless communication node.

In some embodiments, the wireless communication device may identify that the first information element is absent in a configuration previously sent by a wireless communication node (e.g., last serving gNB). The wireless communication device may select N signals as the first information element. A value of the N can be configured by the wireless communication node or reported by the wireless communication device. A value of the N can be determined based on a number of resource sets configured for the wireless communication device or based on a capability of the wireless communication device. At least one or more of the N signals can be selected from a same cell. The at least one or more N signals can come from one cell. For example, if the UE chooses signal 1, 2, 3, 4, 5 as its pathloss RS, signal 1, 2 may come from cell 1, and signal 3, 4, 5 may come from cell 2.

In some embodiments, the N signals can be selected from respectively different cells. The N signals can be selected from configured N_{c} cells. In some embodiments, some of the signals may come from the same cell, and the gNB can also configure N_{c} for the UE. The wireless communication device may receive a cell list indicating the N_{c} cells from the wireless communication node. A type of the N signals can be configured by the wireless communication node. The type may include one of: SSB, PRS, PO, or SIB. A type of the N signals can be configured by the wireless communication device itself.

In some embodiments, the wireless communication device may select the N signals based on a criterion on beam measurement quantity value configured by the wireless communication device node. The criterion on beam measurement quantity value can be an RSRP limitation. The wireless communication device may select the N signals based on N_{b} beams with a highest/lowest average measurement quantity value. The N_{b} can be configured by the wireless communication node.

In some embodiments, the wireless communication device may report the N selected signals to the wireless communication device node. The UE may inform the gNB which signals is selected as pathloss RS, instead of UE sending the N selected signals to the gNB.

In some embodiments, the wireless communication device may identify that the first information element is provided in a configuration sent by a wireless communication node. The first information element can be configured by the wireless communication node as one or more reference signals in a reference signal list. The at least some of the one or more reference signals can be from a same cell. The one or more reference signals can be from respectively different cells. The one or more reference signals can be each a SSB or a PRS. The reference signal list may further indicate a criterion on beam measurement quantity value. The criterion on beam measurement quantity value can be an RSRP limitation.

In some embodiments, the wireless communication device may identify that the second information element is absent in a configuration previously sent by a wireless communication node (e.g., the last serving gNB). The wireless communication device may select K signals as the second information element. A value of the K can be configured by the wireless communication node or reported by the wireless communication device. A value of the K can be determined based on a number of resources or resource sets configured for the wireless communication device or based on a capability of the wireless communication device. One or more of the K signals can be selected from a same cell. The K signals can be selected from respectively different cells. The K signals can be selected from configured K_{c} cells. The wireless communication device may receive a cell list indicating the K_{c} cells from the wireless communication node.

In some embodiments, a type of the K signals can be configured by the wireless communication node. The type may include one of: SSB, PRS, PO, SIB or CSI-RS. A type of the K signals can be configured by the wireless communication device itself. The wireless communication device may select the K signals based on a criterion on beam measurement quantity value configured by the wireless communication device node. The criterion on beam measurement quantity value can be an RSRP limitation.

In some embodiments, the wireless communication device may select the K signals based on K_{b} beams with a highest/lowest average measurement quantity value. K_{b} can be configured by the wireless communication node. The wireless communication device may report the K selected signals to the wireless communication device node.

In some embodiments, the wireless communication device may identify that the second information element is provided in a configuration previously sent by a wireless communication node. The second information element can be configured by the wireless communication node as one or more reference signals in a spatial relation list. Some of the one or more reference signals can be from a same cell. The one or more reference signals can be from respectively different cells. The one or more reference signals can be each a SSB, PRS or CSI-RS. The reference signal list may further indicate a criterion on beam measurement quantity value. The criterion on beam measurement quantity value can be an RSRP limitation.

In some embodiments, the wireless communication device may update the first information element in a slot that satisfies a time limitation configured by a wireless communication node. The wireless communication device may update the second information element in a slot that satisfies a time limitation configured by a wireless communication node.

In some embodiments, the wireless communication device (e.g., a UE) may determine a reference signal for RSRP threshold calculation for the increase/decrease of RSRP for time alignment validation. The reference signal can be a pathloss RS and/or a pathloss reference. The RSRP increase/decrease value can be calculated using the same reference signal in one cell or using the different reference signals in difference cells. The wireless communication device can use the same or different time alignment validation for positioning sounding reference signal transmission in different resource sets.

In some embodiments, a network entity of a core network (e.g., LMF, location management function) may configure time-related information or PRS instance indicator for a first wireless communication device (e.g., a UE) and a second wireless communication device (e.g., a PRU), allowing the first wireless communication device and the second wireless communication device to simultaneously measure a PRS instance or a DL-PRS. The time-related information can be a list of time slots or a list of slot offsets or a list of time windows. And the PRS instance indicator can be a list of periodicity sequences and/or repetition sequences.

In some embodiments, a network entity of a core network (e.g., LMF) can configure for or request to a second network entity (e.g., gNB), time-related information, allowing the first wireless communication device and the second wireless communication device to simultaneously transmit a SRS.

In some embodiments, a network entity (e.g., gNB) of a core network can trigger/activate a first wireless communication device (e.g., a UE) and a second wireless communication device (e.g., a PRU), as indicated in the time-related information, allowing the first wireless communication device and the second wireless communication device to simultaneously transmit a SRS. The time related information can be a list of time slots or a list of slot offsets or a list of time windows.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example spatial relation difference in sounding reference signal (SRS) transmission, in accordance with some embodiments of the present disclosure;

FIG. 4 illustrates an example UE pathloss reference signal (RS) selection (the selected RS can be within the same cell), in accordance with some embodiments of the present disclosure;

FIG. 5 illustrates an example UE pathloss reference signal (RS) selection (the selected RS can be from different cells), in accordance with some embodiments of the present disclosure;

FIG. 6 illustrates an example for UEs applying different spatial relation signal, in accordance with some embodiments of the present disclosure;

FIG. 7 illustrates an example for UE pathloss reference signal (RS) update, in accordance with some embodiments of the present disclosure;

FIG. 8 illustrates an example for same UE pathloss reference signal (RS) update granularity, in accordance with some embodiments of the present disclosure;

FIG. 9 illustrates an example for different UE pathloss reference signal (RS) update granularity, in accordance with some embodiments of the present disclosure;

FIG. 10 illustrates an example for UEs applying different starting points for pathloss reference signal (RS) update, in accordance with some embodiments of the present disclosure;

FIG. 11 illustrates an example inactivePosSRS-RSRP-ChangeThreshold calculation diagram when selecting one pathloss reference signal (RS), in accordance with some embodiments of the present disclosure;

FIG. 12 illustrates an example inactivePosSRS-RSRP-ChangeThreshold calculation diagram when selecting multiple pathloss reference signal (RS), in accordance with some embodiments of the present disclosure;

FIG. 13 illustrates an example for UE sounding reference signal (SRS) configuration in a validity area, in accordance with some embodiments of the present disclosure;

FIG. 14 illustrates an example for UE sounding reference signal (SRS) configuration if pathloss RS is configured/selected per resource set, in accordance with some embodiments of the present disclosure;

FIG. 15 illustrates an example for UE sounding reference signal (SRS) configuration, if pathloss RS is configured/selected per resource, in accordance with some embodiments of the present disclosure;

FIG. 16 illustrates an example inactivePosSRS-RSRP-ChangeThreshold calculation diagram when selecting one pathloss reference, in accordance with some embodiments of the present disclosure;

FIG. 17 illustrates an example inactivePosSRS-RSRP-ChangeThreshold calculation diagram when selecting multiple pathloss references, in accordance with some embodiments of the present disclosure;

FIG. 18 illustrates an example for downlink positioning reference signal (DL-PRS) instance determination, in accordance with some embodiments of the present disclosure; and

FIG. 19 illustrates a flow diagram for positioning, in accordance with an embodiment of the present disclosure.

### DETAILED DESCRIPTION

### 1. Mobile Communication Technology and Environment

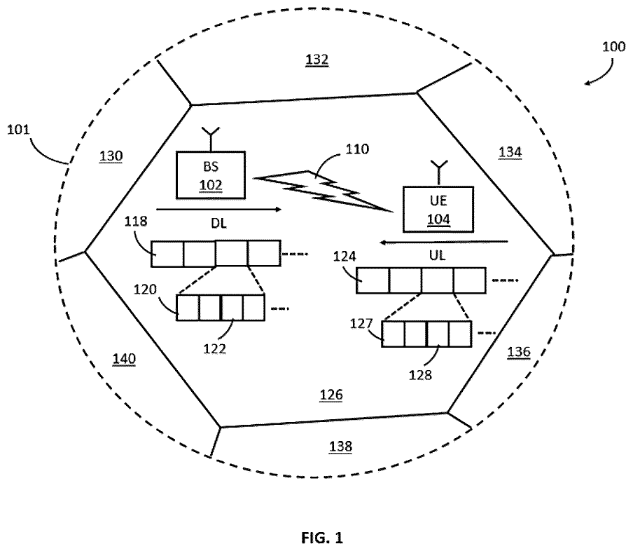

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

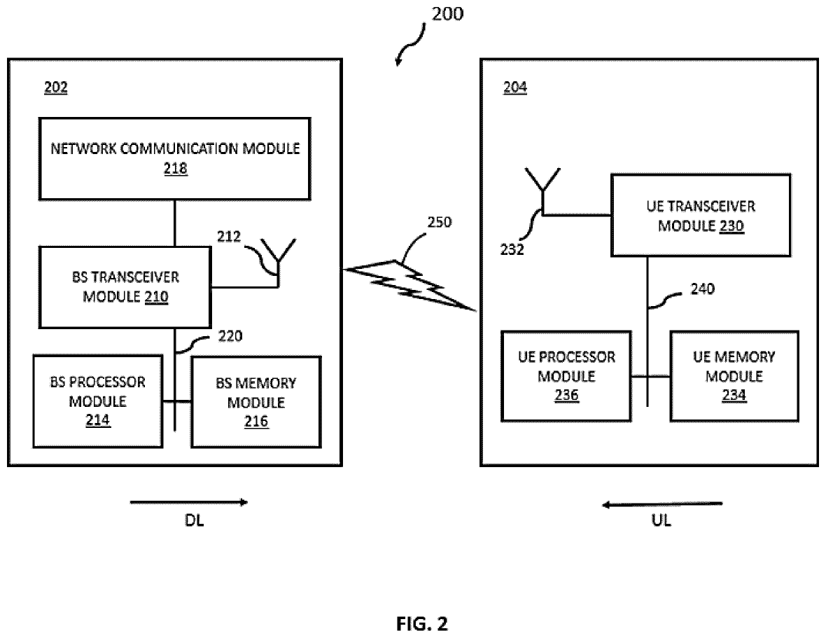

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for High Accuracy Positioning for Low Power User Equipments (UEs)

In recent years, many positioning technologies are proposed in 5G-enabled network to achieve high accuracy positioning for UE. To reduce power consumption for low power and high accuracy positioning (LPHAP) devices, a UE may enter sleep state when not receiving or processing system or positioning signals during the positioning procedure. If a UE moves to another cell's coverage, cell re-selection is performed, the UE may have to reach to RRC_CONNECTED to receive a new sounding reference signal (SRS) for positioning configuration embedded in RRC reconfiguration. The most significant UE power consumption may come from power state transfer (e.g., from sleep state to active state). A frequent state transition may cause a huge power consumption. This disclosure introduces several solutions to decrease the power consumption for UE while not deteriorating the positioning performance.

In a UL positioning procedure, a UE may get a new SRS for positioning configuration when the UE moves to a new cell or the previous configuration is invalid (e.g., a related timer being expired). In a UL positioning procedure, a UE may establish RRC connection when receiving SRS configuration or updating SRS configuration, which is power consuming for LPHAP devices. Therefore, SRS for positioning configurations in a validity area that comprises multiple cell can be performed. More specifically, a UE may adopt a single set of SRS for positioning configuration when UE is within the validity area. However, some of the SRS configuration parameters may not be applied across other cells, such as spatial relation, pathloss RS, p0, and alpha.

A UE may calculate the required transmission power using a RS resource obtained from the SSB of the serving cell when UE is not provided with pathlossReferenceRS-Pos in RRC_CONNECTED state. But for LPHAP, UEs can be expected to not enter RRC_CONNECTED state frequently. If a UE is in RRC_INACTIVE state and determines that the UE is not able to accurately determine the SRS transmission power, the UE may not transmit SRS in the configured SRS resource set. Moreover, the need for fields to be present for pathlossReferenceRS-Pos can be M, which means, upon receiving a message with the field absent, the UE may maintain the current value. However, if the UE moves to a new cell while maintaining the previous pathlossReferenceRS-Pos configuration, the UE cannot calculate the SRS transmission power accurately, the SRS resource cannot be transmitted successfully. Therefore, the pathlossReferenceRS-Pos configured by the last serving gNB can be invalid for SRS transmission power determination for UE not in RRC_CONNECTED state when the UE camps on a new cell.

The spatial relation between a reference signal and the target SRS for positioning can be configured in SRS-SpatialRelationlnfoPos. The UE can transmit the target SRS resource(s) within the SRS resource set according to the spatial relation. In a SpatialRelationlnfoPos IE, the spatial relation can be synchronization signal block (SSB)/channel status information reference signal (CSI-RS)/sounding reference signal (SRS) in the serving cell or SSB/positioning reference signal (PRS) of the neighbor cell. When the UE moves to a new cell, a spatial relation may be invalid.

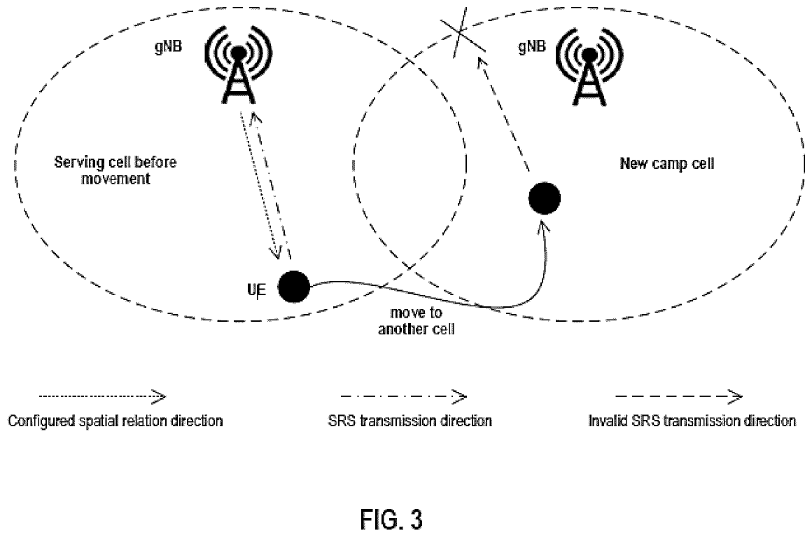

FIG. 3 illustrates an example spatial relation difference in sounding reference signal (SRS) transmission, in accordance with some embodiments of the present disclosure. As shown in FIG. 3, a UE may receive spatial relation configuration from its last serving cell before movement, and a SRS can be transmitted with a configured beam direction. If the UE moves to another cell but the spatial relation remains unchanged, the transmitted SRS cannot be detected by a receiver. Therefore, spatial relation information configured by the last serving gNB can be invalid when the UE camps on a new cell. In present disclosure, several solutions on the potential enhancement for LPHAP considering the problems mentioned above can be performed.

### Implementation Example 1

This implementation example provides a signaling and UE behavior enhancements when a pathlossReferenceRS-Pos is absent in a SRS for positioning configuration.

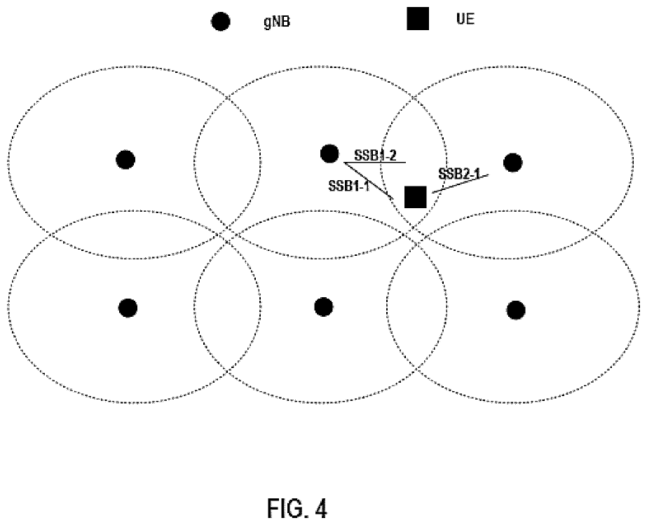

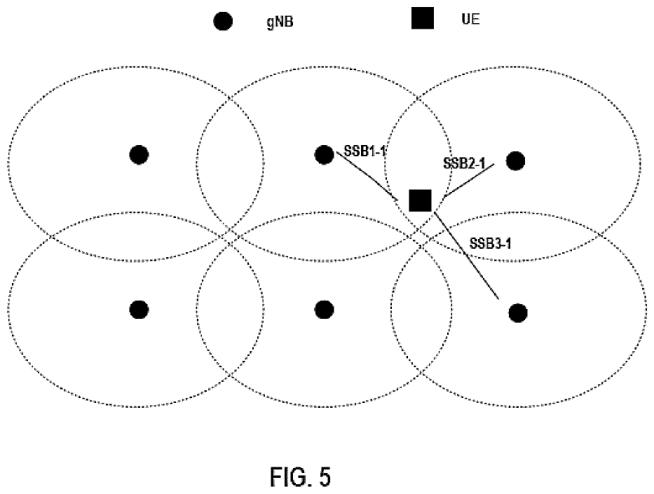

A UE can select N signals with high/low reference signal received power (RSRP) as pathlossReferenceRS-Pos for positioning SRS transmission. For example, the pathloss reference signal (RS) of SRS for positioning is the received signals with the N highest/lowest beam measurement quantity value within the validity area. N can be configured by gNB or reported by the UE. The exact value of N can be determined based on the number of resource sets configured for a UE or up to UE's capability. As shown in FIG. 4 and FIG. 5, for a UE, the selected N signals can be in the same cell (one cell can include more than one pathloss RS for a UE) or in different cells (at most one signal can be selected as pathloss RS within a cell). All of the selected signals can be SSB. In these two examples, the configured/reported value of N may equal 3, and SSB with highest RSRP can be selected as pathloss RS. In FIG. 4, two pathloss RS can be selected from cell 1 (e.g., SSB 1-1 and SSB 1-2), and one pathloss RS is selected from cell 2 (e.g., SSB 2-1). In FIG. 5, all of these pathloss RS can be selected from different cells (e.g., SSB 1-1 from cell 1, SSB 2-1 from cell 2 and SSB 3-1 from cell 3). If the UE selects pathloss RS from the same or difference cells, the gNB can configure the number of cells (N_{c}) that the UE can select from. Under this condition, the UE may select pathloss RS from N_{c} cells. More specifically, the gNB can configure the pathloss RS cell list for the UE. The cell list may comprise a phycellID of these cells. The UE can choose pathloss RS from the cells in the configured pathloss cell list. The pathloss cell list can be or not be a subset of the cells in the validity area.

After pathloss RS selection, the UE can calculate the transmission power for positioning SRS in RRC_INACTIVE state, and may transmit the SRS for positioning with the calculated power using the selected pathloss RS. In such way, gNBs that transmit the selected pathloss RS can receive the SRS for positioning with proper power, further improve the positioning performance. If the UE selects N signals with higher RSRP, the gNB near UE can receive SRS for positioning with proper Rx power, and on the contrary, if the UE selects the signals with lower RSRP, the gNB far away from the UE can receive SRS for positioning with proper Rx power.

Alternatively, the gNB can configure a type of the selected pathloss RS. The pathloss RS type can comprise one or more of the following choices: a synchronization signal block (SSB), a positioning reference signal (PRS), a paging occasion (PO), or a system information block (SIB). If this type field is configured for a UE, a UE may select the reference from the configured type. If this type field is absent, the type of pathloss RS selection can be up to UE implementation.

Alternatively, gNB can configure a RSRP threshold for the UE when the UE is selecting pathloss RS. The UE may only choose the signals with larger (when selecting high RSRP RS)/lower (when selecting low RSRP RS) RSRP than the configured threshold.

For another perspective, the UE can select the pathloss RS for positioning SRS as the reference signal with Nb beams with the highest/lowest average measurement quantityvalue. The average measurement quantity value can be the linear/nonlinear average of the measured reference signals and Nb can be configured by gNB. Alternatively, the beam measurement quantity value can be above/below a configured threshold. The threshold for linear/nonlinear average can be configured by the gNB. Alternatively, gNB can configure a criterion on beam measurement quantity value for UE, for example, an RSRP limitation. UE can select the pathloss RS based on the beam measurement limitation. More specifically, UE can select the signal with smaller/lager RSRP value from the signals that meets the configured limitation. In this way, the TRP/gNB that far away from the UE within in the validity area can also receive the desired SRS.

And also, a UE can select the signals with greater beam measurement quantity value or RSRP as its pathloss RS, and calculate the transmission power with a certain power offsets, to make sure the TRP/gNB that far away from the UE can also receive the desired SRS.

Alternatively, the UE can select pathloss RS from several cells. The reference signals in the selected cells can be with higher/lower average RSRP. For example, the UE can measure the RSRP of SSB with index k from different cells. An avg(RSRP k, cell i) may denote the average RSRP of SSB k in time domain transmitted in cell i. The UE may select the SSB from the cells whose avg(RSRP k, cell i) is greater or lower than a given threshold as pathloss RS.

After finishing the RSRP measurement of these signals and selecting the desired pathloss RS, the UE can report the selected pathloss RS to the gNB. If the selected pathloss RS includes SSB, the reported pathlossReferenceRS-Pos may comprise at least one of following IEs: PhysCellId: the physical cell identity of the corresponding pathloss RS; and/or SSB-Index: index of the SSB of the corresponding pathloss RS.

If the selected pathloss reference signal(s) include PRS, the reported pathlossReferenceRS-Pos may comprise at least one of following IEs: dl-PRS-ID: UE specific TRP ID that transmitting the corresponding pathloss RS; dl-PRS-ResourceSetId: PRS-ResourceSet ID of a PRS resourceSet that contains the corresponding pathloss RS; and/or dl-PRS-ResourceId: PRS-Resource ID of a PRS resource that corresponding to the pathloss RS.

Alternatively, the UE can report the RSRP together with the measured signals. The reported measurement report of SSB may comprise at least one of following IEs: PhysCellId: the physical cell identity of the received signal; SSB-Index: index of the SSB of the received signal; and/or RSRP of the received signal.

The reported measurement report of PRS may comprise at least one of following IEs: dl-PRS-ID: UE specific TRP ID that transmitting the received signal; dl-PRS-ResourceSetId: PRS-ResourceSet ID of a PRS resourceSet that contains the received signal; dl-PRS-ResourceId: PRS-Resource ID of a PRS resource that corresponding to the received signal; and/or RSRP of the received signal. The gNB can further configure the pathloss RS for UE based on the reported measurement results.

After pathloss RS selection/configuration, the UE can transmit the positioning SRS for different resource sets using the calculated transmission power based on the selected/configured pathloss RS. For example, as illustrated in FIG. 4 (FIG. 5), the UE may transmit SRS in resource set 1 using pathloss RS SSB 1-1 (e.g., SSB 1-1), may transmit SRS in resource set 2 using pathloss RS SSB 1-2 (e.g., SSB 2-1), and may transmit SRS in resource set 3 using pathloss RS SSB 2-1 (e.g., SSB 3-1).

With this method, the UE can select its pathloss RS when camping on different cells in the SRS configuration validity area, and the selected pathloss RS can provide reasonable basis for transmission power calculation of positioning SRS. In such way, the power consumption can be greatly reduced because of the better transmission power estimation while maintaining high positioning accuracy, and the UE doesn't have to enter RRC_CONNECTED state to get the updated pathloss RS when the UE moves within the validity area.

### Implementation Example 2

This implementation example provides a signaling and UE behavior enhancements when the pathlossReferenceRS-Pos is provided in a SRS for positioning configuration.

For SRS configuration in the validity area, the last serving gNB can configure a pathloss RS list for the UE. The configured pathloss RS list may include one or more reference signals for the UE. The UE can choose one or more from these reference signals as its pathloss RS for positioning SRS transmission. The signals in configured pathloss RS list may come from different cells within the validity area, or may come from the same cell within the validity area. The signals in the configured pathloss RS list can be SSB, PRS or other reference signals. In such way, the gNB can be aware of the possible pathloss RS that the UE is choosing and the UE can select relatively suitable pathloss RS for positioning SRS transmission.

From another perspective, the validity criteria of pathloss RS and UE behavior can be considered if the validity criteria of pathloss RS is not met. The gNB can configure the RSRP threshold for the pathloss RS list. If the measured RSRP of the reference signals from the list is lower than the threshold, the UE can consider/regard this pathloss RS as invalid. A request for pathloss RS configuration update may be required. In such way, the pathloss RS can be updated in time once upon the UE enters a new validity area.

Alternatively, the UE can update its pathloss RS based on the spatial relation selection/configuration. More specifically, the UE can take the same reference signal as its spatial relation and pathloss RS.

### Implementation Example 3

This implementation example provides a signaling and UE behavior enhancements when the SpatialRelationInfoPos is absent in the SRS for positioning configuration.

A UE can select K signals with high/low RSRP as SpatialRelationlnfoPos for positioning SRS transmission, e.g., a spatial relation of SRS for positioning is the received signals with K highest/lowest beam measurement quantity value within the validity area. K can be configured by the gNB or reported by the UE. The exact value of K can be determined based on the number of resource configured for a UE or up to UE's capability. For a UE, the selected K signals can be in the same cell (one cell can include more than one spatial relation signals for a UE) or in the different cell (at most one signal can be selected as spatial relation signal within a cell), all of the selected signals are SSB. The detailed example can be the same as that of pathloss RS (implementation example 1). If a UE selects spatial relation from the same or difference cells, a gNB can configure the number of cells (K_{c}) that UE can select from. Under this condition, the UE may select spatial relation from Kc cells. More specifically, the gNB can configure the spatial relation list for UE. The cell list may comprise the phycellID of these cells. The UE can choose spatial relation from the cells in the configured spatial relation cell list. The spatial relation cell list can be or not be a subset of the cells in the validity area.

After spatial relation selection, the UE can transmit the SRS for positioning with the selected spatial relation signal in RRC_INACTIVE state. In such way, TRPs (transmission-reception point) can receive the positioning SRS with proper beams, may further improve the positioning accuracy. If the UE selects K signals with higher RSRP, the gNB near UE may receive SRS for positioning with proper Rx beam. On the contrary, if the UE selects the signals with lower RSRP, the gNB far away from the UE may receive SRS for positioning with proper Rx beam.

Alternatively, the gNB can configure the type of the selected spatial relation. The spatial relation type can comprise one or more of the following choices: a SSB, a PRS, a PO, a CSI-RS, or a SIB. If this type field is configured for a UE, the UE may select the reference signal from the configured type. If this type field is absent, the type of spatial relation selection can be up to UE implementation.

Alternatively, the gNB can configure a RSRP threshold for UE when the UE selects a spatial relation. The UE can choose the signals greater than (when selecting high RSRP RS)/lower than (when selecting low RSRP RS) the configured RSRP threshold.

From another perspective, the UE can select the spatial relation signals for positioning SRS as the reference signal with K_{b} beams with the highest/lowest average measurement quantity value. The average measurement quantity value can be the linear/nonlinear average of the measured reference signals and K_{b} can be configured by the gNB. Alternatively, the beam measurement quantity value can be above/below a configured threshold. The threshold for linear/nonlinear average can be configured by the gNB. Alternatively, gNB can configure a criterion on beam measurement quantity value for UE, for example, an RSRPlimitation. UE can select the spatial relation based on the limitation. More specifically, UE can select the signal with smallest RSRP value from the signals that meets the configured limitation. In this way, the TRP/gNB that far away from the UE within in the validity area can also receive the desired SRS with the selected spatial relation.

Alternatively, the UE can select spatial relation from several cells. The reference signals in the selected cells can be with higher/lower average RSRP. For example, the UE can measure the RSRP of SSB with index k from different cells. An avg(RSRP k, cell i) may denote the average RSRP of the SSB k in time domain transmitted in cell i. The UE may select the SSB from the cells whose avg(RSRP k, cell i) is greater or lower than a given threshold as its spatial relation.

After finishing the RSRP measurement of these signals and selected the desired spatial relation, the UE can report the selected spatial relation to the gNB. If the selected spatial relation signal(s) include a SSB, the reported SRS-SpatialRelationlnfoPos may comprise the following IEs: PhysCellId: the physical cell identity of the corresponding spatial relation; and/or SSB-Index: index of the SSB of the corresponding spatial relation.

If the selected signal(s) include a PRS, the reported SRS-SpatialRelationInfoPos may comprise the following IEs: dl-PRS-ID: UE specific TRP ID that transmitting the corresponding spatial relation; dl-PRS-ResourceSetId: PRS-ResourceSet ID of a PRS resourceSet that contains the corresponding spatial relation; and/or dl-PRS-ResourceId: PRS-Resource ID of a PRS resource that corresponding to the spatial relation.

Alternatively, the UE can report the RSRP together with the measured signals. The reported measurement report of SSB may comprise the following IEs: PhysCellId: the physical cell identity of the received signal; SSB-Index: index of the SSB of the received signal; and/or RSRP of the received signal.

The reported measurement report of PRS may comprises the following IEs: dl-PRS-ID: UE specific TRP ID that transmitting the received signal; dl-PRS-ResourceSetId: PRS-ResourceSet ID of a PRS resourceSet that contains the received signal; dl-PRS-ResourceId: PRS-Resource ID of a PRS resource that corresponding to the received signal; and/or RSRP of the received signal.

The gNB can further configure the spatial relation for UE based on the reported measurement results. Alternatively, the gNB can configure the spatial relation for UE based on the pathloss RS configuration. Alternatively, the UE can select spatial relation based on the pathloss RS configuration (if pathloss RS is configured) or based on the pathloss RS selection (as listed in implementation example 1).

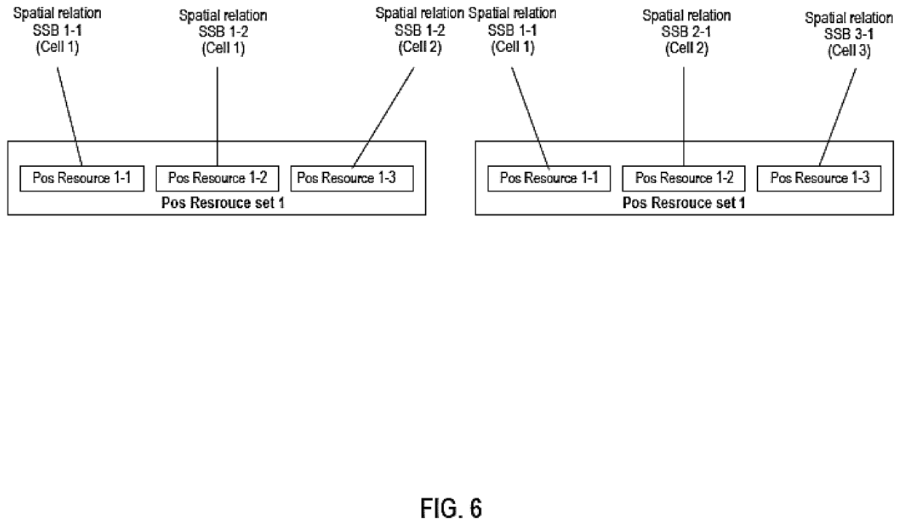

FIG. 6 illustrates an example for UEs applying different spatial relation signal, in accordance with some embodiments of the present disclosure. As shown in FIG. 6, a UE can transmit the SRS for positioning within different resources using the evaluated/configured spatial relation. With this method, the UE can select its spatial relation when camping on different cells in the SRS for positioning configuration validity area, and the selected spatial relation can provide reasonable basis for the transmission of positioning SRS.

### Implementation Example 4

This implementation example provides a signaling and UE behavior enhancements when the SpatialRelationlnfoPos is provided in the SRS for positioning configuration.

For SRS configuration in the validity area, the last serving gNB can configure spatial relation list for a UE. The configured spatial relation list may include one or more reference signals for the UE. The UE can choose one or more from these reference signals as its spatial relation for positioning SRS transmission. The signals in configured spatial relation list can come from different cells within the validity area, or may come from the same cell within the validity area. The signals in configured spatial relation list can be SSB, PRS, CSI-RS or other reference signals. In such way, the gNB can be aware of the possible spatial relation that UE is choosing and UE can select relatively suitable spatial relation for positioning SRS transmission.

From another perspective, the validity criteria of spatial relation and UE behavior can be considered if it determines that the validity criteria of spatial relation is not met. The gNB can configure the RSRP threshold for the spatial relation list. If the measured RSRP of the reference signals from the list is lower than the threshold, the UE can regard this spatial relation as invalid. A request for spatial relation configuration update can be utilized. In such way, the spatial relation can be updated in time once upon the UE enters a new validity area.

A pathloss RS and spatial relation may share the same or use different RSRP threshold(s). Taking this into account, the gNB can configure a common RSRP threshold for both pathloss RS and spatial relation. Alternatively, the gNB can further configure an indicator specifying whether the configured RSRP threshold can be shared for both pathloss RS and spatial relation. If the configured RSRP threshold can be shared for both pathloss RS and spatial relation, the indicator can be set as 1; otherwise, the indicator can be 0.

### Implementation Example 5

This implementation example provides a time limitation of pathloss RS and spatial relation change/update occasion.

A gNB can configure a time limitation or granularity M1 for UE's pathloss RS change occasion for each resource set. Alternatively, different resource (sets) can share the same time limitation or granularity. The configuration can be included in RRC release information. If a UE applies the configured time limitation or granularity M1, it indicates/means that the UE may change the pathloss RS only in several slots.

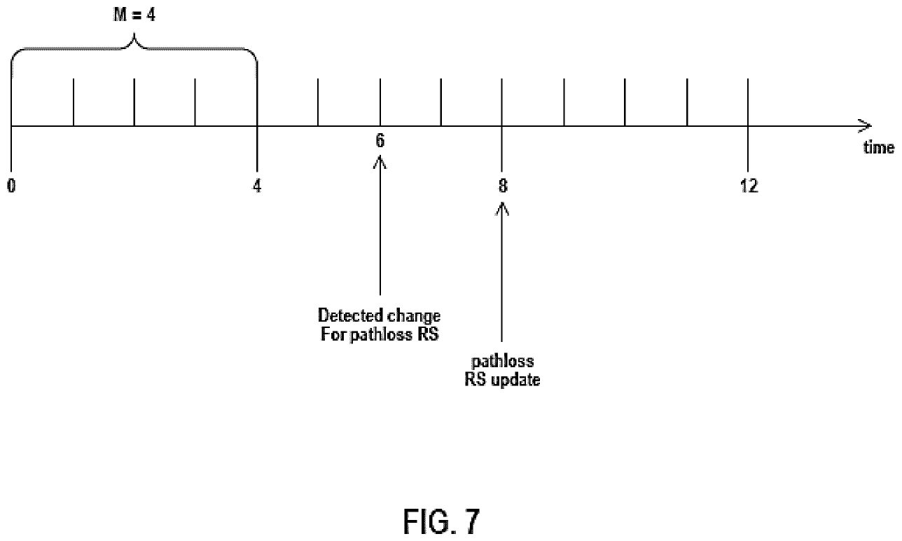

For example, if M1=4, the UE may change the pathloss RS only when the slots number is an integral multiple of 4. FIG. 7 illustrates an example for UE pathloss reference signal (RS) update, in accordance with some embodiments of the present disclosure. As shown in FIG. 7, a UE may detect there is a change in slot 6, and the UE may use another pathloss RS to transmit its positioning SRS. In such case, the UE may delay the pathloss RS update, e.g., update its pathloss RS in slot 8.

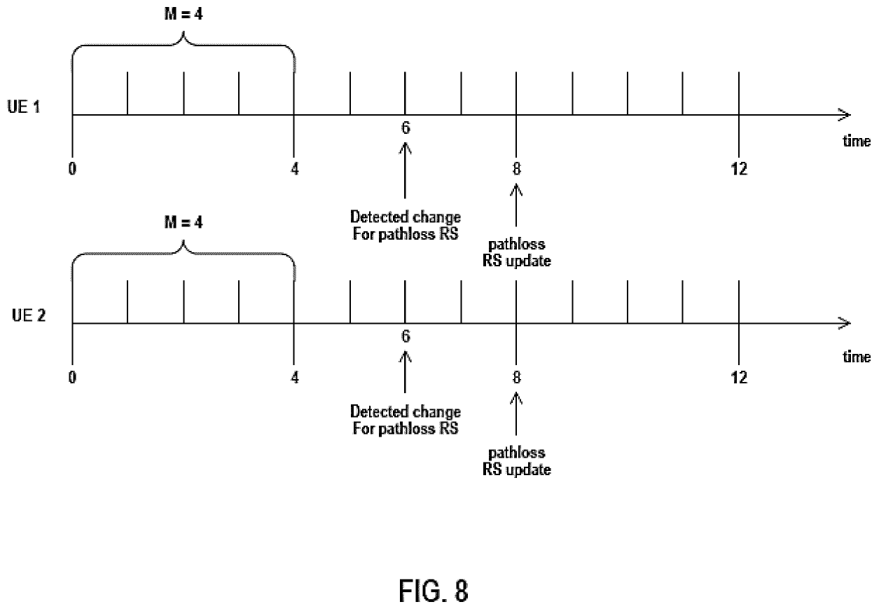

The gNB can configure same or different time limitation or granularity M1 for different UEs within the validity area. FIG. 8 illustrates an example for same UE pathloss reference signal (RS) update granularity, in accordance with some embodiments of the present disclosure. As shown in FIG. 8, the configured M1 for both UE 1 and UE 2 can be the same, the UE 1 and the UE 2 can update the pathloss RS at the same time slot.

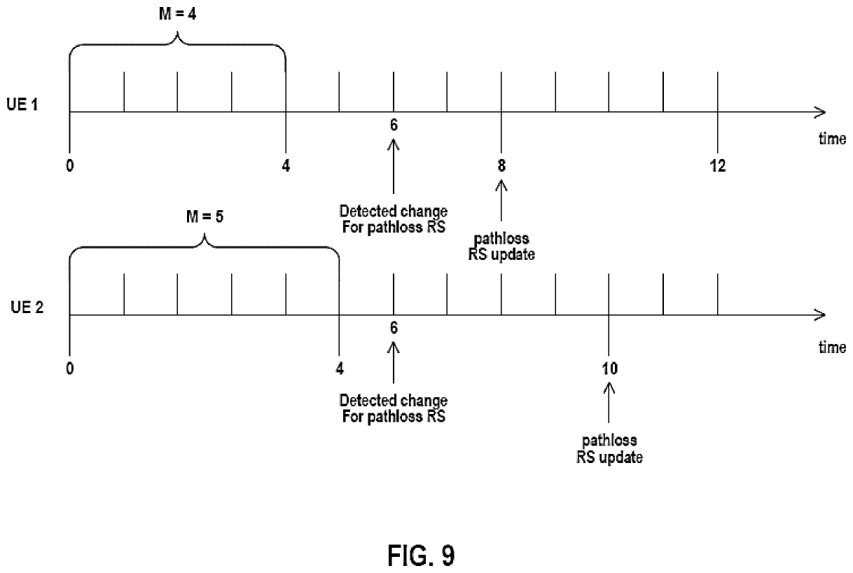

FIG. 9 illustrates an example for different UE pathloss reference signal (RS) update granularity, in accordance with some embodiments of the present disclosure. FIG. 9 shows the different M1 configuration details, e.g., the configured M1 for UE 1 is 4, for UE 2 is 5. The UE 1 and the UE 2 may detect changes in the same time slot, but the update behavior can be executed in different slots, e.g., the UE 1 updates in slot 8, and the UE 2 updates in slot 10.

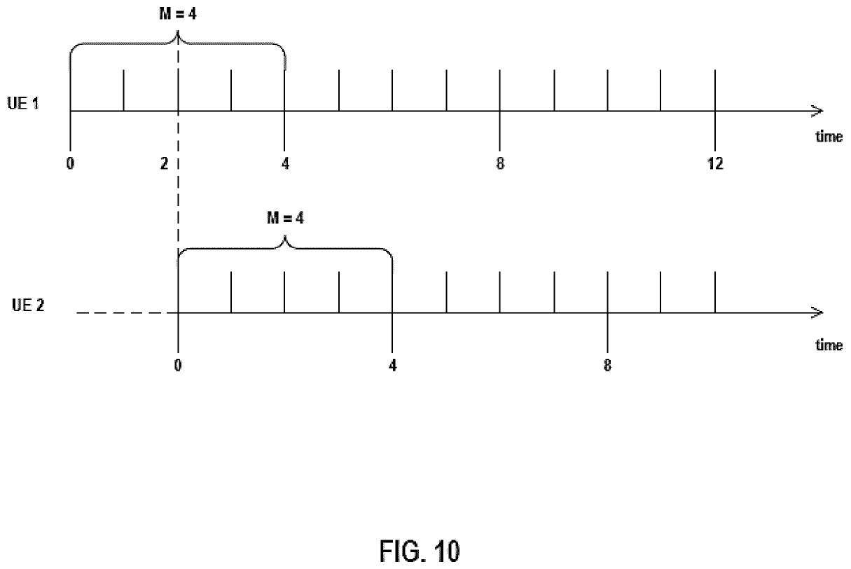

Alternatively, different UE can share the same or use different starting point in time domain. FIG. 10 illustrates an example for UEs applying different starting points for pathloss reference signal (RS) update, in accordance with some embodiments of the present disclosure. FIG. 10 shows the case when two UEs use different starting point. If UEs use different starting point for pathloss RS update, the starting point in time domain can be the time slot when the UE enters the coverage of the SRS configuration validity area.

Similarly, the gNB can configure the time limitation or granularity M2 for UE's spatial relation change occasion for each resource. Alternatively, different resources can share the same time limitation granularity. The detailed change occasion of spatial relation for different UEs can share the same or use different M2.

Pathloss RS and spatial relation may share the same or different change occasion. Taking this into account, the gNB can configure a common M for both pathloss RS and spatial relation. Alternatively, the gNB can further configure an indicator specifying whether the configured M can be shared for both pathloss RS and spatial relation. If the configured RSRP threshold can be shared for both pathloss RS and spatial relation, the indicator can be set as 1; otherwise, the indicator can be 0. In such way, TRPs can be aware of when the UE may switch its pathloss RS and/or spatial relation, and can further improve the efficiency of receiving and decoding SRS for positioning signals.

### Implementation Example 6

A RRC may configure at least one of the following parameters for the validation of SRS transmission in RRC_INACTIVE: inactivePosSRS-RSRP-ChangeThreshold: RSRP threshold for the increase/decrease of RSRP for time alignment validation. The timing advance (TA) of uplink SRS transmission for UE can be invalid when the volatility of pathloss RS RSRP is greater than the configured parameters, e.g., inactivePosSRS-RSRP-ChangeThreshold. In the following discussion, this threshold is denoted as Rₜₕ. Specifically, if the pathloss RS configured in SRS-Config or the pathloss RS selected by UE (as listed in implementation example 1) is taken as the RSRP change threshold validation, the UE may store the RSRP of pathloss RS, denote as Rₚ, and when the UE moves, the RSRP may vary with the distance between UE and TRP. The instantaneous value of RSRP at time t can be denoted as Rt. If the difference of Rₜ and Rₚ is great than the configured threshold (e.g., |Rₜ−Rₚ|>Rₜₕ), the UE may stop transmitting SRS.

The RSRP of pathloss RS may change rapidly when the UE moves, especially when the UE camps on a new cell. Moreover, the pathloss RS configuration can be also invalid when UE camps on a new cell (as illustrated in previous embodiments), whether Rₜ refers to the pathloss RS of the previous cell or refers to the pathloss RS of the new cell can be specified. The UE may stop transmitting SRS if the TA valid criterion is not satisfied (inactivePosSRS-TimeAlignmentTimer is expired or the RSRP difference of the RS beyond inactivePosSRS-RSRP-ChangeThreshold). Therefore, the TA valid criterion can be different across multiple cells for UE in RRC_INACTIVE state. The present disclosure proposes several solutions for the TA validation criterion when taking pathloss RS as RSRP change threshold basis.

Case 1: UE may select ONE pathloss RS for different SRS resource sets when transmitting SRS.

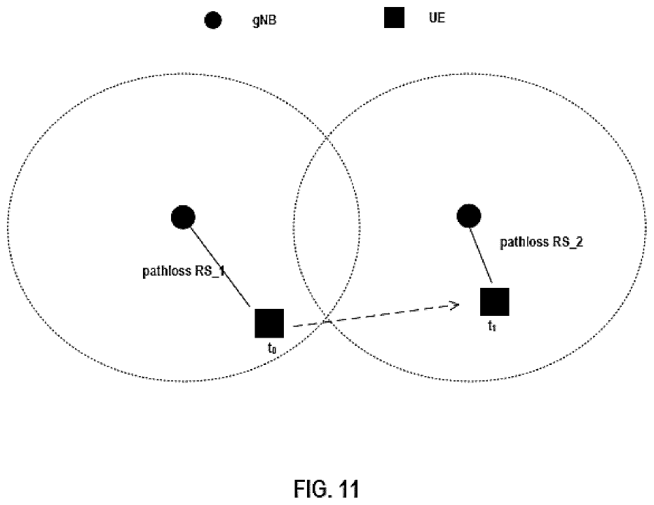

FIG. 11 illustrates an example inactivePosSRS-RSRP-ChangeThreshold calculation diagram when selecting one pathloss reference signal (RS), in accordance with some embodiments of the present disclosure. As shown in FIG. 11, at time t₀, the UE may take pathloss RS_1 as its pathloss RS and the stored RSRP of pathloss RS_1 at time t₀ is Rₚ₀. When the UE moves to the coverage of another cell at time t₁, the UE may update its pathloss RS as pathloss RS_2. The RSRP of pathloss RS_2 at time t₁ can be Rₜ₁, and the RSRP of pathloss RS_1 at time t₁ can be Rₚ₁. For the RSRP change threshold definition, the following options can be considered:

Option 1: A UE may calculate the RSRP change details using the same pathloss RS, e.g., the RSRP change refers to the difference of Rₚ₀ and Rₚ₁. These two values may refer to the RSRP of pathloss RS_1 at different time. If the difference of Rₚ₀ and Rₚ₁ is great than the configured threshold, e.g., |Rₚ₀−Rₚ₁|>Rₜₕ, the UE may stop transmitting SRS. With this option, the adopted RSRP may refer to the same pathloss RS. The RSRP change details can better reflect the movement of UE.

Option 2: A UE may calculate the RSRP change details using the updated pathloss RS selection/configuration, e.g., the RSRP change refers to the difference of Rₚ₀ and Rₜ₁. These two values may refer to the RSRP of pathloss RS_1 at time t₀ and pathloss RS_2 at time t₁. If the difference of Rₚ₀ and Rₜ₁ is great than the configured threshold, e.g., |Rₚ₀−Rₜ₁|>Rₜₕ, the UE may stop transmitting SRS. With this option, the adopted RSRP may refer to the updated pathloss RS.

Case 2: UE may select different pathloss RS for different SRS resource sets when transmitting SRS.

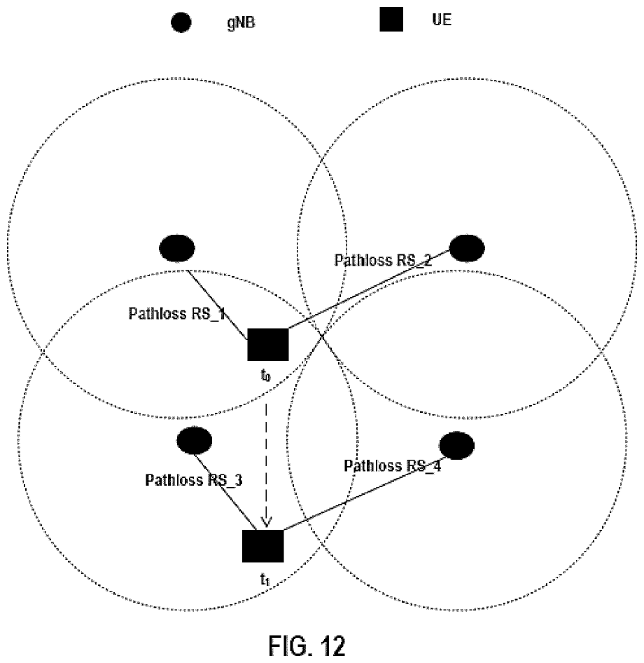

FIG. 12 illustrates an example inactivePosSRS-RSRP-ChangeThreshold calculation diagram when selecting multiple pathloss reference signal (RS), in accordance with some embodiments of the present disclosure. As shown in FIG. 12, the UE can be configured with 2 SRS for positioning resource sets, and at time t₀, the pathloss RS of these two sets can be pathloss RS_1 and pathloss RS_2, respectively. The UE may take pathloss RS_1 and pathloss RS_2 as its pathloss RS for different SRS resource sets. The stored (at time t₀) RSRP of pathloss RS_1 and pathloss RS_2 can be Rₚ₁ and Rₚ₂, respectively. When the UE moves to the coverage of another cell at time t₁, the UE may update its pathloss RS as pathloss RS_3 and pathloss RS_4. The RSRP of pathloss RS_3 and pathloss RS_4 at time t₁ are Rₜ₃ and Rₜ₄, and the RSRP of pathloss RS_1 and pathloss RS_2 at time t₁ can be Rₜ₁ and Rₜ₂. For the RSRP change threshold definition, the following options can be considered:

Option 1: the UE may calculate the RSRP change details using the same pathloss RS, e.g., the RSRP change of resource set 1 may refer to the difference of Rₚ₁ and Rₜ₁, the RSRP change of resource set 2 may refer to the difference of Rₚ₂ and Rₜ₂.

On one hand, the UE can transmit SRS in different resource set separately, e.g., if |Rₚ₁−Rₜ₁|>Rₜₕ, the UE may stop transmitting SRS in resource set 1, and if |Rₚ₂−Rₜ₂|>Rₜₕ, the UE may stop transmitting SRS in resource set 2. Similar methods can also be used when UEs are configured with more resource sets. Alternatively, the gNB/LMF can configure different RSRP change threshold Rₜₕ₁, Rₜₕ₂, . . . , Rₜₕₙ for different resource sets. n can be the number of resource sets configured for a UE.

On the other hand, the UE can transmit SRS in different SRS resource set with the same threshold validity criterion, e.g., if |Rₚ₁−Rₜ₁|>Rₜₕ or |Rₚ₂−Rₜ₂|>Rₜₕ. The UE may stop transmitting SRS in both resource sets.

From another perspective, the UE can transmit SRS in different SRS resource set based on the average RSRP changes. Specifically, the UE can store the RSRP as the average of pathloss RS for different resource sets, e.g., the stored RSRP in FIG. 12 can be (Rₚ₁+Rₚ₂)/2, denote as Rₚₐ, and the RSRP of pathloss RS_1 and pathloss RS_2 at time t₁ is (Rₜ₁+Rₜ₂)/2, denote as Rₜₐ, if |Rₚₐ−Rₜₐ|>Rₜₕ, the UE may stop transmitting SRS in both resource sets.

Option 2: the UE may calculate the RSRP change details using the updated pathloss RS selection/configuration, e.g., the RSRP change of resource set 1 may refer to the difference of Rₚ₁ and Rₜ₃, the RSRP change of resource set 2 may refer to the difference of Rₚ₂ and Rₜ₄.

The UE can transmit SRS in different resource sets separately, e.g., if |Rₚ₁−Rₜ₃|>Rₜₕ. The UE may stop transmitting SRS in resource set 1, and if |Rₚ₂−Rₜ₄|>Rₜₕ, the UE may stop transmitting SRS in resource set 2. On the other hand, the UE can transmit SRS with the same threshold validity criterion, e.g., if |Rₚ₁−Rₜ₃|>Rₜₕ or |Rₚ₂−Rₜ₄|>Rₜₕ, the UE may stop transmitting SRS in both resource sets.

From another perspective, the UE can transmit SRS in different SRS resource sets based on the average RSRP changes. Specifically, the UE can store the RSRP as the average of pathloss RS_1 and pathloss RS_2 at time t₀, e.g., the stored RSRP can be (Rₚ₁+Rₚ₂)/2, denote as Rₚₐ, and the RSRP of pathloss RS_3 and pathloss RS_4 at time t₁ can be (Rₜ₃+Rₜ₄)/2, denote as Rₜₐₙ, if |Rₚₐ−Rₜₐ|>Rₜₕ, the UE may stop transmitting SRS in both resource sets.

In such way, the UE can specify the detailed pathloss RS change threshold determination process, and execute proper SRS transmitting operations when the pathloss RS can be updated.

In some embodiments, pathloss RS can play two roles, e.g., (1) used as the reference signal for TA RSRP change threshold definition, (2) used for SRS transmission power control.

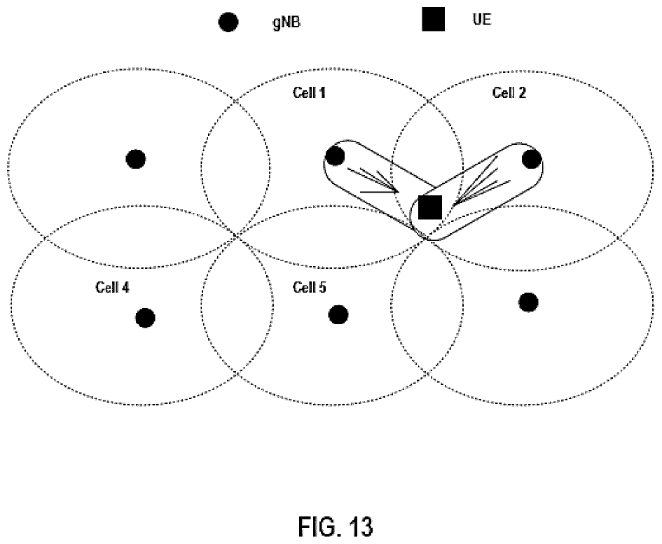

Following figures provide optional SRS configurations on UE side. FIG. 13 illustrates an example for UE sounding reference signal (SRS) configuration in a validity area, in accordance with some embodiments of the present disclosure. As shown in FIG. 13, the UE may transmit SRS for positioning in different resource set towards different direction, e.g., in this example, resource set 1 can be mainly for cell 1, resource set 2 can be main for cell 2.

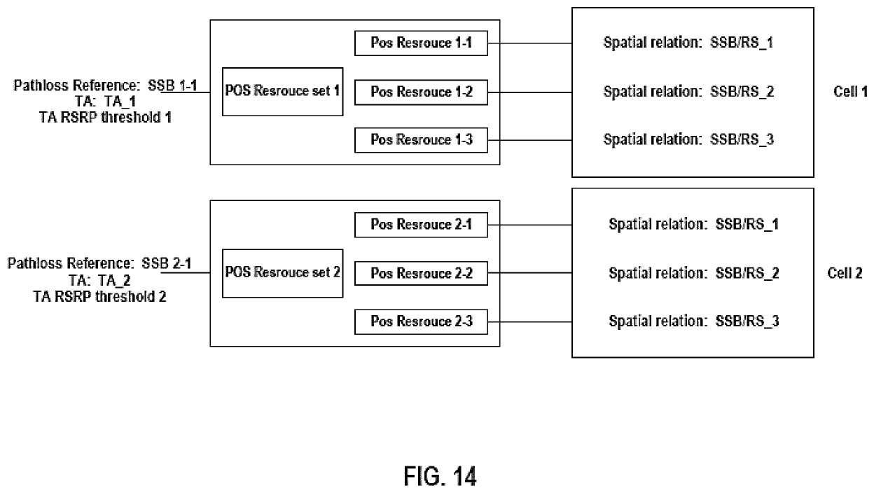

The detailed timing advance (TA), RSRP threshold, pathloss RS and spatial relation can be shown in FIG. 14. The UE can select or be configured with different pathloss RS/TA/TA RSRP change threshold in different resource set. The spatial relation can be selected/configured per SRS resource. FIG. 14 illustrates an example for UE sounding reference signal (SRS) configuration, in accordance with some embodiments of the present disclosure.

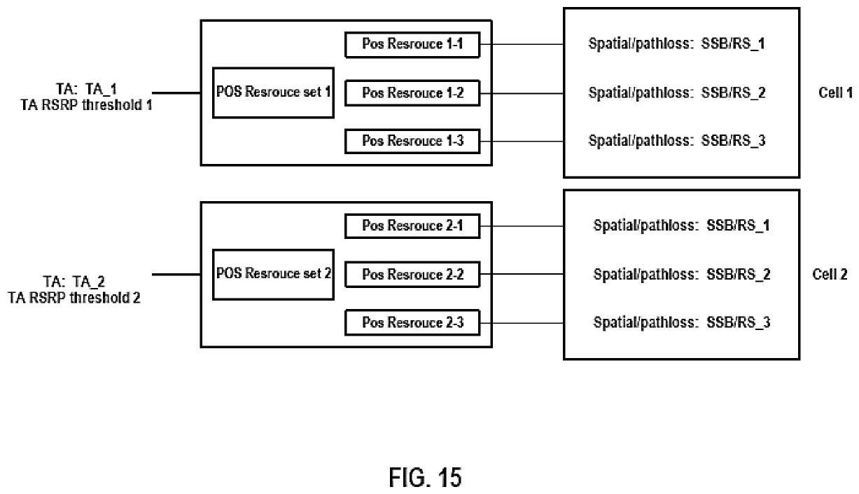

Alternatively, pathloss RS can bind with the spatial relation, as shown in FIG. 15. In the options mentioned above mentioned, different positioning resource set can be configured with the same pathloss RS, TA and TA RSRP threshold. FIG. 15 illustrates an example for UE sounding reference signal (SRS) configuration, in accordance with some embodiments of the present disclosure.

### Implementation Example 7

As a supplement to implementation example 6, this implementation example provides the RSRP change threshold definition when UE uses the measured SSB as its pathloss reference. The pathloss reference can be different from the pathloss RS configured in SRS-Config. In the following discussion, the threshold configured in inactivePosSRS-RSRP-ChangeThreshold can be denoted as Rₜₕ.

In this condition, the UE may store the RSRP of measured pathloss reference. The pathloss reference can be SSB measured by UE, denote as Rₚ. When the UE moves, the RSRP may vary with the distance between UE and TRP, the instantaneous value of RSRP at time t can be denoted as Rt. If the difference of Rₜ and Rₚ is great than the configured threshold, e.g., |Rₜ−Rₚ|>Rₜₕ, the UE may stop transmitting SRS. This implementation example proposes several solutions for the TA validation criterion when UE takes the measured pathloss reference as RSRP change threshold basis.

Case 1: UE may select ONE pathloss reference for different SRS resource sets when transmitting SRS.

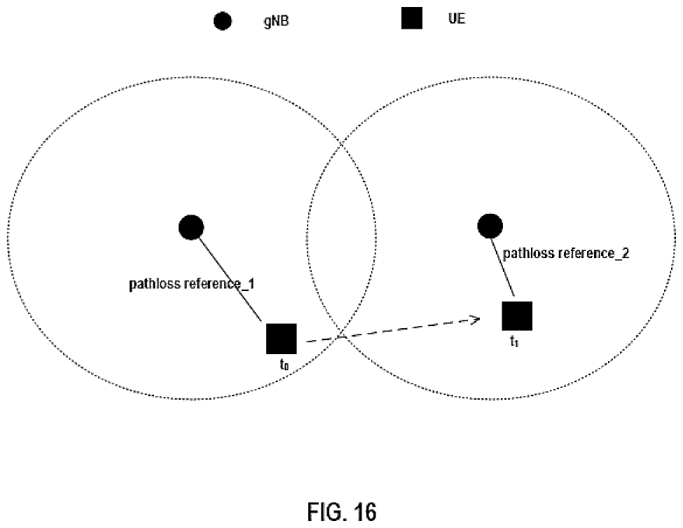

FIG. 16 illustrates an example inactivePosSRS-RSRP-ChangeThreshold calculation diagram when selecting one pathloss reference, in accordance with some embodiments of the present disclosure. As shown in FIG. 16, at time t₀, UE take pathloss reference_1 as its pathloss reference and the stored RSRP of pathloss reference_1 at time t₀ is Rₚ₀. When the UE moves to the coverage of another cell at time t₁, the UE may update its pathloss reference as pathloss reference_2. The RSRP of pathloss reference_2 at time t₁ can be denoted Rₜ₁, and the RSRP of pathloss reference_1 at time t₁ can be denoted Rₚ₁. For the RSRP change threshold definition, the following options can be considered:

Option 1: The UE may calculate the RSRP change details using the same pathloss reference, e.g., the RSRP change may refer to the difference of Rₚ₀ and Rₚ₁. These two values may refer to the RSRP of pathloss reference_1 at different time. If the difference of Rₚ₀ and Rₚ₁ is great than the configured threshold, e.g., |Rₚ₀−Rₚ₁|>Rₜₕ, the UE may stop transmitting SRS. With this option, the adopted RSRP may refer to the same pathloss reference, the RSRP change details can better reflect the movement of the UE.

Option 2: The UE may calculate the RSRP change details using the updated pathloss reference, e.g., the RSRP change may refer to the difference of Rₚ₀ and Rₜ₁. These two values may refer to the RSRP of pathloss reference_1 at time t₀ and pathloss reference_2 at time t₁. If the difference of Rₚ₀ and Rₜ₁ is great than the configured threshold, e.g., |Rₚ₀−Rₜ₁|>Rₜₕ, the UE may stop transmitting SRS. With this option, the adopted RSRP may refer to the updated pathloss reference.

Case 2: UE may select different pathloss reference for different SRS resource sets when transmitting SRS.

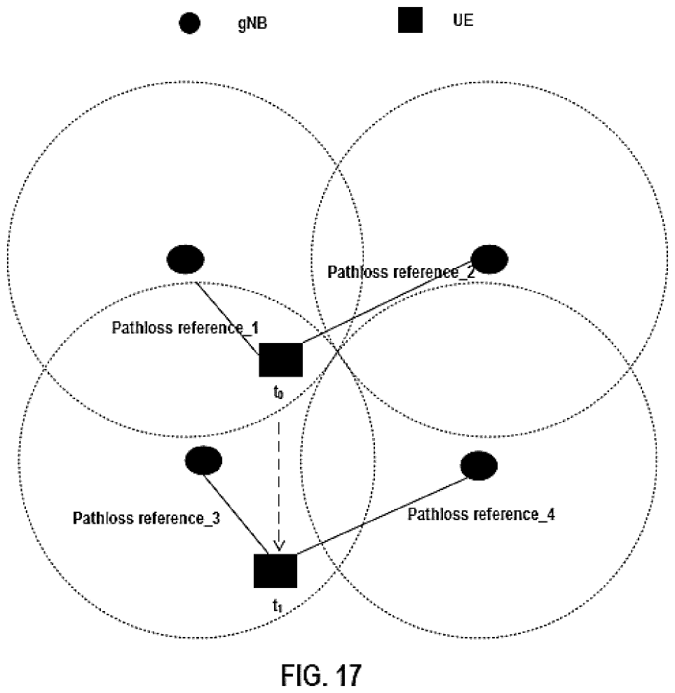

FIG. 17 illustrates an example inactivePosSRS-RSRP-ChangeThreshold calculation diagram when selecting multiple pathloss references, in accordance with some embodiments of the present disclosure. As shown in FIG. 17, the UE can be configured with 2 SRS for positioning resource sets, and at time t₀, the pathloss references of these two sets can be pathloss reference_1 and pathloss reference_2, respectively. The UE may take pathloss reference_1 and pathloss reference_2 as its pathloss references for different SRS resource sets and the stored (at time t₀) RSRP of pathloss reference_1 and pathloss reference_2 can be Rₚ₁ and Rₚ₂, respectively. When the UE moves to the coverage of another cell at time t₁, the UE may update its pathloss references as pathloss reference_3 and pathloss reference_4. The RSRP of pathloss reference_3 and pathloss reference_4 at time t₁ can be denoted Rₜ₃ and Rₜ₄, and the RSRP of pathloss reference_1 and pathloss reference_2 at time t₁ can be denoted Rₜ₁ and Rₜ₂. For the RSRP change threshold definition, the following options can be considered:

Option 1: The UE may calculate the RSRP change details using the same pathloss references, e.g., the RSRP change of resource set 1 refer to the difference between Rₚ₁ and Rₜ₁, the RSRP change of resource set 2 may refer to the difference between Rₚ₂ and Rₜ₂.

The UE can transmit SRS in different resource sets separately, e.g., if |Rₚ₁−Rₜ₁|>Rₜₕ, the UE may stop transmitting SRS in resource set 1, and if |Rₚ₂−Rₜ₂|>Rₜₕ, the UE may stop transmitting SRS in resource set 2. Similar methods can also be used when UEs are configured with more resource sets. Alternatively, gNB/LMF can configure different RSRP change thresholds Rₜₕ₁, Rₜₕ₂, . . . , Rₜₕₙ for different resource sets. n can be the number of resource sets configured for a UE.

On the other hand, the UE can transmit SRS in different SRS resource sets with the same threshold validity criterion, e.g., if |Rₚ₁−Rₜ₁|>Rₜₕ or |Rₚ₂−Rₜ₂|>Rₜₕ, the UE may stop transmitting SRS in both resource sets.

From another perspective, the UE can transmit SRS in different SRS resource sets based on the average RSRP changes. Specifically, the UE can store the RSRP as the average of pathloss references for different resource sets, e.g., the stored RSRP in FIG. 17 can be (Rₚ₁+Rₚ₂)/2, denote as Rₚₐ, and the RSRP of pathloss reference_1 and pathloss reference_2 at time t1 is (Rₜ₁+Rₜ₂)/2, denote as Rₜₐ, if |Rₚₐ−Rₜₐ|>Rₜₕ, the UE may stop transmitting SRS in both resource sets.

Option 2: The UE may calculate the RSRP change details using the updated pathloss reference, e.g., the RSRP change of resource set 1 refer to the difference of Rₚ₁ and Rₜ₃, the RSRP change of resource set 2 refers to the difference of Rₚ₂ and Rₜ₄.

The UE can transmit SRS in different resource sets separately, e.g., if |Rₚ₁−Rₜ₃|>Rₜₕ, the UE may stop transmitting SRS in resource set 1, and if |Rₚ₂−Rₜ₄|>Rₜₕ, the UE may stop transmitting SRS in resource set 2. On the other hand, the UE can transmit SRS with the same threshold validity criterion, e.g., if |Rₚ₁−Rₜ₃|>Rₜₕ or |Rₚ₂−Rₜ₄|>Rₜₕ, the UE may stop transmitting SRS in both resource sets.

From another perspective, the UE can transmit SRS in different SRS resource set based on the average RSRP changes. Specifically, the UE can store the RSRP as the average of pathloss reference_1 and pathloss reference_2 at time t₀, e.g., the stored RSRP can be (Rₚ₁+Rₚ₂)/2, denote as Rₚₐ, and the RSRP of pathloss reference_3 and pathloss reference_4 at time t₁ is (Rₜ₃+Rₜ₄)/2, denote as Rₜₐₙ, if |Rₚₐ−Rₜₐₙ|>Rₜₕ, the UE may stop transmitting SRS in both resource sets.

In such way, the UE can specify the detailed pathloss reference change threshold determination process, and execute proper SRS transmitting operations when the pathloss reference is updated.

In some embodiments, the pathloss reference derivation for TA validation can be as follows:
1> if nrofSS-BlocksToAverage or absThreshSS-BlocksConsolidation is not present or if absThreshSS-BlocksConsolidation is present and the highest beam measurement quantity value is below or equal to absThreshSS-BlocksConsolidation:
2> derive the downlink pathloss reference RSRP for TA validation as the highest beam measurement quantity value.
1> else:
2> derive the downlink pathloss reference RSRP for TA validation as the linear average of the power values of up to nrofSS-BlocksToAverage of the highest beam measurement quantity values above absThreshSS-BlocksConsolidation.

In the previous examples, the UE may derive the downlink pathloss reference RSRP for TA validation as the highest beam measurement quantity value, e.g., max(RSRP, cell i)<absThreshSS-BlocksConsolidation, which means that the beam quality value is less than the configured threshold absThreshSS-BlocksConsolidation.

It should be noted that the UE can also derive the downlink pathloss reference RSRP for TA validation as the linear average of the power values of up to nrofSS-BlocksToAverage of the highest beam measurement quantity values. The pathloss reference mentioned in previous example can also be a linear average of the power values of up to nrofSS-BlocksToAverage beams, e.g., the RSRP of pathloss reference_i represent a linear average of the power values of up to nrofSS-BlocksToAverage beams in cell i, wherein i=1, 2, 3, 4. The pathloss reference RSRP change validation method can also be applied with this option.

In some embodiments, pathloss reference, which is measured by UE, can be used as the reference signal for TA RSRP change threshold definition. The pathloss RS can be used for SRS transmission power control. The pathloss reference and the pathloss RS can be two seperate signals.

### Implementation Example 8

Some positioning methods, such as carrier phase positioning (CPP), may require positioning reference unit (PRU) and UE measure the same positioning reference signal (PRS) instance or measure the PRS simultaneously, to improve the accuracy of positioning while executing carrier phase differential. For uplink (UL) positioning process, PRU and UE can be required to transmit SRS for positioning simultaneously in some cases. In such way, a transmission-reception point (TRP) can execute carrier phase differential in CPP when receiving SRS for positioning from PRU and UE.

In some embodiments, the UE and the PRU may measure the same DL-PRS simultaneously in a positioning process. This implementation example provides several solutions to enable UE and PRU measure the same PRS instance or measure the PRS simultaneously.

A LMF can configure the same response time (e.g., indicates the maximum response time as measured between receipt of the RequestLocationInformation and transmission of a ProvideLocationInformation) for positioning reference unit (PRU) and UE in QoS related IEs, which can be included in RequestLocationInformation. In such way, the PRU and UE may have to report the PRS measurement result within the same time limitation. The PRU and the UE may measure the PRS simultaneously.

From another perspective, gNB/LMF can configure the same time slot(s) for PRU and UE for PRS measurement, the configuration may comprise the following IEs: dl-PRS-ID: UE specific TRP ID that transmitting the corresponding PRS; Slot number(s); dl-PRS-ResourceSetId (optional): PRS-ResourceSet ID of a PRS resourceSet that contains the corresponding PRS; and/or dl-PRS-ResourceId (optional): PRS-Resource ID of a PRS resource that corresponding to the PRS instance to be measured. The PRU and the UE may have to measure the PRS at the configured time slot(s).

Alternatively, gNB/LMF can configure a time slot offset list for the PRU and the UE. The gNB/LMF may indicate a time slot offset at which PRU and UE can measure the PRS. The top element in the configured list has the highest measurement priority.

Alternatively, gNB/LMF can configure the same measurement windows for PRU and UE. The configuration may comprise the following IEs: dl-PRS-ID: UE specific TRP ID that transmitting the corresponding PRS; window start time/slot number(s); window end time/slot number(s); dl-PRS-ResourceSetId (optional): PRS-ResourceSet ID of a PRS resourceSet that contains the corresponding PRS; and/or dl-PRS-ResourceId (optional): PRS-Resource ID of a PRS resource that corresponding to the PRS instance to be measured. The PRU and UE can measure the PRS within the configured measurement window.

Alternatively, the number of configured time slots or measurement windows for each DL-PRS resource set can be determined by the number of DL-PRS samples N_sample to be measured, e.g., N_sample=1 or 2 if the UE supports supportedDL-PRS-ProcessingSamples, and N_sample=4 otherwise. The configured time slots can be continuous or discontinuous time slots. Alternatively, this configuration can also be included in on-demand PRS configuration.

Besides configure the time slot(s) or measurement window(s), the gNB/LMF can configure the same DL-PRS instance(s) for PRU and UE. The configuration may comprise the following IEs: dl-PRS-ID: UE specific TRP ID that transmitting the corresponding PRS; periodicity sequence; repetition sequence; dl-PRS-ResourceSetId (optional): PRS-ResourceSet ID of a PRS resourceSet that contains the corresponding PRS; and/or dl-PRS-ResourceId (optional): PRS-Resource ID of a PRS resource that corresponding to the PRS instance to be measured. The PRS instance can be measured by PRU and UE.

Specifically, each DL-PRS resource can be configured with a periodicity and repetition factor as follows:
dl-PRS-Periodicity-and-ResourceSetSlotOffset-r16
NR-DL-PRS-Periodicity-and-ResourceSetSlotOffset-r16,
dl-PRS-ResourceRepetitionFactor-r16 ENUMERATED {n2, n4, n6, n8, n16, n32, . . . }
OPTIONAL, —Need OP

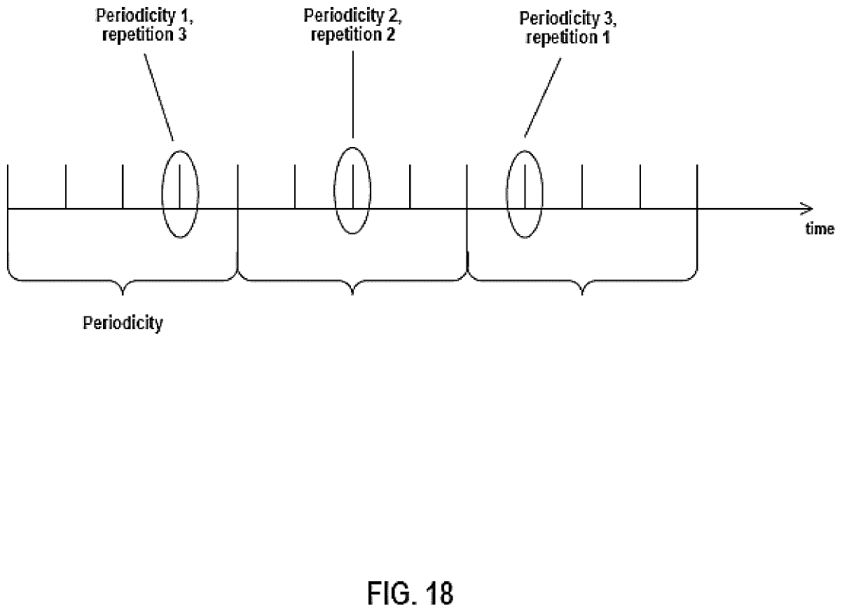

FIG. 18 illustrates an example for downlink positioning reference signal (DL-PRS) instance determination, in accordance with some embodiments of the present disclosure. As shown in FIG. 18, if the periodicity and repetition sequence is configured, the PRU and the UE can determine which DL-PRS instance can be measured.

Alternatively, the gNB/LMF can configure an indicator in the DL-PRS resource and/or DL-PRS resource set configuration, may indicate whether there is a simultaneous DL-PRS requirement in this DL-PRS resource and/or DL-PRS resource set. If there is a simultaneous DL-PRS requirement in this DL-PRS resource and/or DL-PRS resource set, the indicator can be set as 1; otherwise, the indicator can be 0.

Alternatively, the gNB/LMF can configure a priority set in the DL-PRS resource and/or DL-PRS resource set configuration, specifying that the PRS instance in the priority set can be measured with higher priority. The top element in the configured list may have the highest measurement priority. The priority set configuration may comprise one or more of the following IEs: dl-PRS-ID: UE specific TRP ID that transmitting the corresponding PRS; periodicity sequence; repetition sequence; and/or slot number(s).

The UE may report an indicator together with the measurement report. If the reported result is based on the configured PRS instance or time slots, the UE may set the indicator as 1, otherwise the indicator can be 0.

The methods mentioned above can ensure or increase the probability of PRU and UE measuring the same PRS instance or measure PRS simultaneously. In such case, two measurements can have the same time and frequency resources and similar channel environments, further may enable the differential operation among different PRS measurement results. In such way, UE and PRU can receive PRS simultaneously, and may further reduce the relative timing error, phase error, and measurement error of the received signal, thereby improving positioning accuracy without affecting UE's power consumption.

### Implementation Example 9

In some embodiments, a UE and a PRU may transmit SRS for positioning simultaneously in a positioning process. This implementation example may provide several solutions to enable UE and PRU transmit SRS for positioning simultaneously.

A gNB can configure the same slot offset(s) in SRS-Config for PRU and UE for SRS transmission. The PRU and the UE can transmit the SRS for positioning as configured in SRS-Config.

Alternatively, the gNB can trigger the positioning SRS transmission for PRU and UE in DCI downlink control information (DCI). Specifically, the gNB can transmit two DCI, wherein one DCI can be used for triggering UE transmit SRS for positioning in a given time slot, another DCI can be used for triggering PRU transmit SRS for positioning in the time slot.

Alternatively, the LMF can transmit the trigger information or on-demand SRS transmission slot number(s) in NR positioning protocol A (NRPPa) to the gNB, specifying the time slot(s) that PRU and UE can send SRS for positioning simultaneously. The key point can be how to let gNB know in which slot(s) SRS from both PRU and the target UE should be transmitted. Hence, NRPPa signaling can be enhanced accordingly. For instance, the LMF can recommend/request a list of slots or slot offsets or even time windows for potential SRS transmission. The recommended/requested list of slots/slot offsets/windows can be the same for PRU and the target UE to suggest the simultaneous SRS triggering/activation/transmission. The gNB can trigger/activate SRSs in the same window(s)/slot(s) for the two UEs (up to implementation). More specifically, the LMF can request/recommend/configure the time slots/slot offset/windows in POSITIONING ACTIVATION REQUEST, which can be sent by the LMF to cause the NG RAN node to activate/trigger UL SRS transmission by the UE.

The methods mentioned above can ensure or increase the probability of PRU and UE transmitting SRS for positioning with the same configuration simultaneously, in this case, TRP can receive the SRS for positioning resource at the same time, further enable the differential operation among different SRS measurement results. In this way, UE and PRU can transmit SRS simultaneously, further reduce the relative timing error, phase error, and measurement error of the received signal on gNB side, finally improves the positioning accuracy without affecting UE's power consumption.

It should be understood that one or more features from the above implementation examples are not exclusive to the specific implementation examples, but can be combined in any manner (e.g., in any priority and/or order, concurrently or otherwise).

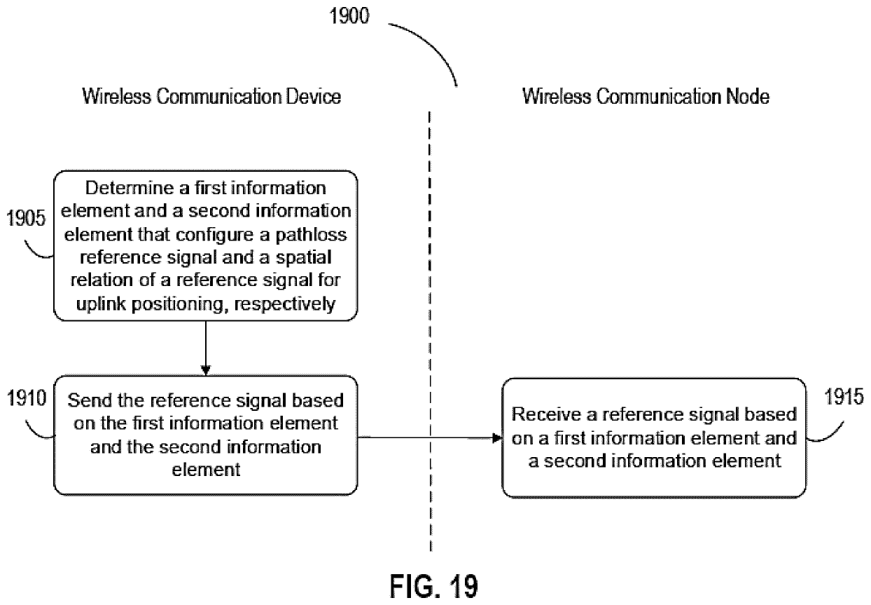

FIG. 19 illustrates a flow diagram of a method 1900 for high accuracy positioning. The method 1900 may be implemented using any one or more of the components and devices detailed herein in conjunction with FIGS. 1-2. In overview, the method 1900 may be performed by a wireless communication device or a wireless communication node, in some embodiments. Additional, fewer, or different operations may be performed in the method 1900 depending on the embodiment. At least one aspect of the operations is directed to a system, method, apparatus, or a computer-readable medium.

A wireless communication device (e.g., a UE) may determine a first information element (e.g., pathlossReferenceRS-Pos) and a second information element (e.g., SpatialRelationlnfoPos) that configure a pathloss reference signal and a spatial relation of a reference signal for uplink positioning, respectively. The wireless communication device may send the reference signal based on the first information element and the second information element to a wireless communication node.

In some embodiments, the wireless communication device may identify that the first information element is absent in a configuration previously sent by a wireless communication node (e.g., last serving gNB). The wireless communication device may select N signals as the first information element. A value of the N can be configured by the wireless communication node or reported by the wireless communication device. A value of the N can be determined based on a number of resource sets configured for the wireless communication device or based on a capability of the wireless communication device. At least one or more of the N signals can be selected from a same cell. The at least one or more N signals can come from one cell. For example, if the UE chooses signal 1, 2, 3, 4, 5 as its pathloss RS, signal 1, 2 may come from cell 1, and signal 3, 4, 5 may come from cell 2.

In some embodiments, the N signals can be selected from respectively different cells. The N signals can be selected from configured N_{c} cells. In some embodiments, some of the signals may come from the same cell, and the gNB can also configure N_{c} for the UE. The wireless communication device may receive a cell list indicating the N_{c} cells from the wireless communication node. A type of the N signals can be configured by the wireless communication node. The type may include one of: SSB, PRS, PO, or SIB. A type of the N signals can be configured by the wireless communication device itself.

In some embodiments, the wireless communication device may select the N signals based on a beam measurement quantity value threshold configured by the wireless communication device node. The beam measurement quantity value threshold can be an RSRP threshold. The wireless communication device may select the N signals based on N_{b} beams with a highest/lowest average measurement quantity value. The Ne can be configured by the wireless communication node.

In some embodiments, the wireless communication device may report the N selected signals to the wireless communication device node. The UE may inform the gNB which signals is selected as pathloss RS, instead of UE sending the N selected signals to the gNB.

In some embodiments, the wireless communication device may identify that the first information element is provided in a configuration sent by a wireless communication node. The first information element can be configured by the wireless communication node as one or more reference signals in a reference signal list. The at least some of the one or more reference signals can be from a same cell. The one or more reference signals can be from respectively different cells. The one or more reference signals can be each a SSB or a PRS. The reference signal list may further indicate a criterion on beam measurement quantity value. The criterion on beam measurement quantity value can be an RSRP limitation.

In some embodiments, the wireless communication device may identify that the second information element is absent in a configuration previously sent by a wireless communication node (e.g., the last serving gNB). The wireless communication device may select K signals as the second information element. A value of the K can be configured by the wireless communication node or reported by the wireless communication device. A value of the K can be determined based on a number of resources or resource sets configured for the wireless communication device or based on a capability of the wireless communication device. One or more of the K signals can be selected from a same cell. The K signals can be selected from respectively different cells. The K signals can be selected from configured K_{c} cells. The wireless communication device may receive a cell list indicating the K_{c} cells from the wireless communication node.

In some embodiments, a type of the K signals can be configured by the wireless communication node. The type may include one of: SSB, PRS, PO, SIB or CSI-RS. A type of the K signals can be configured by the wireless communication device itself. The wireless communication device may select the K signals based on a criterion on beam measurement quantity value configured by the wireless communication device node. The criterion on beam measurement quantity value can be an RSRP limitation.

In some embodiments, the wireless communication device may select the K signals based on K_{b} beams with a highest/lowest average measurement quantity value. K_{b} can be configured by the wireless communication node. The wireless communication device may report the K selected signals to the wireless communication device node.

In some embodiments, the wireless communication device may identify that the second information element is provided in a configuration previously sent by a wireless communication node. The second information element can be configured by the wireless communication node as one or more reference signals in a spatial relation list. Some of the one or more reference signals can be from a same cell. The one or more reference signals can be from respectively different cells. The one or more reference signals can be each a SSB, PRS or CSI-RS. The reference signal list may further indicate a criterion on beam measurement quantity value. The criterion on beam measurement quantity value can be an RSRP limitation.

In some embodiments, the wireless communication device may update the first information element in a slot that satisfies a time limitation configured by a wireless communication node. The wireless communication device may update the second information element in a slot that satisfies a time limitation configured by a wireless communication node.

In some embodiments, the wireless communication device (e.g., a UE) may determine a reference signal for RSRP threshold calculation for the increase/decrease of RSRP for time alignment validation. The reference signal can be a pathloss RS and/or a pathloss reference. The RSRP increase/decrease value can be calculated using the same reference signal in one cell or using the different reference signals in difference cells. The wireless communication device can use the same or different time alignment validation for positioning sounding reference signal transmission in different resource sets.

In some embodiments, a network entity of a core network (e.g., LMF, location management function) may configure time-related information or PRS instance indicator for a first wireless communication device (e.g., a UE) and a second wireless communication device (e.g., a PRU), allowing the first wireless communication device and the second wireless communication device to simultaneously measure a PRS instance or a DL-PRS. The time-related information can be a list of time slots or a list of slot offsets or a list of time windows. The PRS instance indicator can be a list of periodicity sequences and/or repetition sequences.

In some embodiments, a network entity of a core network (e.g., LMF) can configure for or request to a second network entity (e.g., gNB), time-related information, allowing the first wireless communication device and the second wireless communication device to simultaneously transmit a SRS.

In some embodiments, a network entity (e.g., gNB) of a core network can trigger/activate a first wireless communication device (e.g., a UE) and a second wireless communication device (e.g., a PRU), as indicated in the time-related information, allowing the first wireless communication device and the second wireless communication device to simultaneously transmit a SRS. The time related information can be a list of time slots or a list of slot offsets or a list of time windows.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method, comprising:
receiving, by a wireless communication device from a network entity of a core network, a configuration comprising an indication of one or more time windows,
wherein the configuration allows the wireless communication device to measure a positioning reference signal (PRS) instance or a downlink PRS (DL-PRS) within the one or more time windows.

2. The wireless communication method of claim 1, wherein the configuration comprises an indication of a plurality of time windows.

3. The wireless communication method of claim 1, wherein the configuration comprises an indication of the PRS instance or the DL-PRS.

4. The wireless communication method of claim 1, wherein the configuration comprises: transmission-reception point (TRP) identifier, window start time, and identifier of PRS resource set.

5. A wireless communication device, comprising:
at least one processor configured to:
receive, via a receiver from a network entity of a core network, a configuration comprising an indication of one or more time windows,
wherein the configuration allows the wireless communication device to measure a positioning reference signal (PRS) instance or a downlink PRS (DL-PRS) within the one or more time windows.

6. The wireless communication device of claim 5, wherein the configuration comprises an indication of a plurality of time windows.

7. The wireless communication device of claim 5, wherein the configuration comprises an indication of the PRS instance or the DL-PRS.

8. The wireless communication device of claim 5, wherein the configuration comprises: transmission-reception point (TRP) identifier, window start time, and identifier of PRS resource set.

9. A wireless communication method, comprising:
providing, by a network entity of a core network to a wireless communication device, a configuration comprising an indication of one or more time windows,
wherein the configuration allows the wireless communication device to measure a positioning reference signal (PRS) instance or a downlink PRS (DL-PRS) within the one or more time windows.

10. The wireless communication method of claim 9, wherein the configuration comprises an indication of a plurality of time windows.

11. The wireless communication method of claim 9, wherein the configuration comprises an indication of the PRS instance or the DL-PRS.

12. The wireless communication method of claim 9, wherein the configuration comprises: transmission-reception point (TRP) identifier, window start time, and identifier of PRS resource set.

13. A network entity of a core network, comprising:
at least one processor configured to:
provide, to a wireless communication device, a configuration comprising an indication of one or more time windows,
wherein the configuration allows the wireless communication device to measure a positioning reference signal (PRS) instance or a downlink PRS (DL-PRS) within the one or more time windows.

14. The network entity of claim 13, wherein the configuration comprises an indication of a plurality of time windows.

15. The network entity of claim 13, wherein the configuration comprises an indication of the PRS instance or the DL-PRS.

16. The network entity of claim 13, wherein the configuration comprises: transmission-reception point (TRP) identifier, window start time, and identifier of PRS resource set.
